(19) United States
(12) Patent Application Publication
(10) Pub. No.: US 2013/0099881 A1
(43) Pub. Date: Apr. 25, 2013

(54) Short period super-mini undulator

(71) Applicants: Alex K. Deyhim, Ithaca, NY (US); Joseph D. Kulesza, Binghamton, NY (US)

(72) Inventors: Alex K. Deyhim, Ithaca, NY (US); Joseph D. Kulesza, Binghamton, NY (US)

(21) Appl. No.: 13/317,679

(22) Filed: Oct. 25, 2011

(51) Int. Cl. H01F 6/06; H01F 7/06

(52) U.S. Cl. 335/216; 29/605

(57) ABSTRACT

A small superconducting undulator with a period less than 1 cm, referred to here as a “super-mini” undulator. The embodiment of the super-mini encompasses of two coils wound bifilarly around a pair of bobbins in a racetrack configuration, such that the currents in adjacent coil segments run antiparallel to each other. If such coils are arranged alongside each other, separated only by a small gap on the order of a couple of millimeters, a spatially alternating magnetic field is produced that makes a passing electron beam undulate and emit undulator radiation. The wound bobbins are mounted within a frame and combined with upper and lower pole pieces to close gap between the wire coils.

### CROSS-REFERENCE TO RELATED APPLICATIONS

Not applicable

### STATEMENT REGARDING FEDERALLY SPONSORED RESEARCH OR DEVELOPMENT

Not applicable

### SEQUENCE LISTING OR PROGRAM

Not applicable

### BACKGROUND OF THE INVENTION

The field of short-period superconducting undulators, called “super-mini undulators”, represents an exciting emerging field with great potential to increase the photon energy of synchrotrons and FELs. Super-minis are tightly wound superconducting coils that create a spatially alternating field with a small gap that makes a passing electron beam undulate and emit undulator radiation. The photon energy is much higher than that of conventional undulators at the same electron energy, owing to the short period length. Similarly, a particular photon energy requires a much smaller electron energy, providing considerable cost savings of accelerator operation and construction.

The development of superconducting mini-undulators started in the early 1990s with work at Brookhaven National Laboratory (BNL) (Ben-Zvi et al., Nucl. Instrum. Methods, A 297, 301, 1990) and Karlsruhe Institute of Technology (KIT) (Moser et al. German Patent P 41 01 094.9-33, Jan. 16, 1991). In 1998, KIT demonstrated the first photon production with a super-mini with a period length of 3.9 mm (Hezel et al., J. Synchrotron Rad. 5, 448, 1998; Hezel et al., Free Electron Lasers 1999, J. Feldhaus, H. Weise, eds., pp. 11-103, North Holland, 2000). This super-mini consisted of two coils wound bi-filarly in analogy to a solenoid. In the basic set-up of two coils in close proximity, planar and elliptical superconducting mini-undulators were built for the ANKA storage ring (Casalbuoni et al., Phys. Rev. ST Accel. Beam, 9, 010702, 2006; Bernhard et al., Proceedings of EPAC 2004, Lucerne, Switzerland, July 2004) The next step towards the most basic geometry was achieved by proposing the single-coil superconducting mini-undulator (Moser and Diao, PCT Application PCT/SG2009/000338, Sep. 14, 2009; Moser, Krevet and Holzapfel, German Patent Application p 41 01 094.9-33, Jan. 16, 1991; Diao and Moser, Horizons in World Physics Volume 267, D. Matteri, L. Futino, eds., pp. 321-332, Nova Science Publishers, Hauppauge, N.Y., USA, 2010).

If such coils are arranged alongside each other, separated only by a small gap of the order of a couple of millimeters, a spatially alternating magnetic field is produced that makes a passing electron beam undulate and emit undulator radiation. The advantageous properties of the super-mini undulator can be revealed through consideration of the following three formulas:

$$\begin{matrix}λ = \frac{{λ}_{u}}{2 n {γ}^{2}} ( 1 + \frac{{K}^{2}}{2} + {( γϑ )}^{2} ) & ( 1 ) \\ K = 0.934 {B}_{0} [ T ] {λ}_{u} [ cm ] & ( 2 ) \\ \begin{matrix}P [ W ] = 6.33 {E}^{2} [ G e V ] I [ A ] {B}_{0}^{2} [ T ] L [ cm ] \\ = 7.26 {E}^{2} [ G e V ] I [ A ] {N}_{u} \frac{{K}^{2}}{{λ}_{u} [ cm ]}\end{matrix} & ( 3 )\end{matrix}$$

Eq. 1 describes the wavelength of undulator photons, λ, in terms of the undulator period length, λᵤ, the harmonic number, n, which can be take on odd integer values of 1, 3, 5, 7, and so on, the relativistic Lorentz factor of the electron beam passing through the undulator, γ, the emission angle, θ, which is zero in the average direction of electron propagation, and the so-called wiggler/undulator parameter K.

Eq. 2 describes the wiggler/undulator parameter, K, which is a linear function of the peak magnetic field, B₀.

Eq. 3 describes the total power emitted from a planar undulator, P, where I is the electron beam current, L=Nᵤλᵤ, is the total undulator length, and Nᵤ is the number of undulator periods.

It can be seen immediately that the wavelength of the emitted photons is linearly proportional to the period length at constant K. To keep K constant when λᵤ, is reduced, the peak magnetic field must increase, which is why superconducting coils are necessary. An increase of the magnetic field while keeping the electron energy, the beam current, and the undulator length constant also increases the total power delivered by the undulator. Moreover, reducing the undulator period while keeping the electron energy, beam current, number of periods, and K constant, also raises the total power. We also see that tuning the photon wavelength, which is typically achieved by varying K, can be achieved by varying the peak magnetic field, which is directly controlled by the current through the superconducting coil.

The benefits of exploiting these parameters are substantial cost savings, as it represents the ultimate in size reduction conceivable for a superconducting undulator. The device described herein uses only one coil instead of the standard two coils used in modern superconducting undulators (Kim et al., Proc. 2003 Particle Accelerator Conference, p. 1020, IEEE Catalog Number: 03CH374). Consequently, the size, weight, and cost of the proposed device can be reduced by a factor of two. All other advantages of superconducting mini-undulators including short period, high peak magnetic field, and facile tunability by means of the varying the current through the superconductor are preserved.

### SUMMARY OF THE INVENTION

This device utilizes a single superconducting wire that is wound bifilarly around two bobbins in unique winding pattern that facilitates a very short period. The wire is initially wrapped under tension in a “racetrack” formation. The bobbins are first wound in one direction filling every other groove alternating top and bottom. After the first set of grooves are filled, the wire is reversed and the remaining grooves are filled. This produces a set of wire segments in which the currents run in opposite directions on the top and bottom of the bobbins to produce the undulating field. The wires are wound in such a way that within a single turn, a wire segment in the top groove returns on the adjacent groove on the bottom.

The bobbins are machined with grooves to accept and secure the wire segments. The bobbins can be machined to accept multiple turns per groove. The grooves are separated by several millimeters and the entire longitudinal length of the embodiment described herein is 100 mm. The length can easily be extrapolated to any desired length. The wound bobbins are then mounted between two end plates that are designed to facilitate the relative horizontal positions of the bobbins.

Upper and lower pole pieces are designed to receive the wire coil segments and must be placed in sync with the bobbins in order to maintain tension throughout the entire superconducting wire coil, and allow gradual movement of the bobbins through contact with curved relief regions. The racetrack configuration reaches its final configuration by moving the upper and lower pole pieces closer together along the vertical axis while the mounted bobbins are brought closer together along the horizontal axis. This is performed while these components are constrained between the two end plates. After the transformation is complete, the final gap between the upper pole piece and lower pole piece should be on the order of millimeters.

### BRIEF DESCRIPTION OF THE DRAWINGS

The invention as described herein with references to subsequent drawings, contains similar reference characters intended to designate like elements throughout the depictions and several views of the depictions. It is understood that in some cases, various aspects and views of the invention may be exaggerated or blown up (enlarged) in order to facilitate a common understanding of the invention and its associated parts.

FIG. 1 shows the overall cryostat design.

FIG. 2 shows a cross-sectional view of the winding of the superconducting (SC) wire around two bobbins in a racetrack winding configuration.

FIG. 3 shows a bobbin under construction.

FIG. 4 is a depiction of the wound bobbins mounted in between the front and rear end plates.

FIG. 5 is a depiction of the grooves of a pole piece.

FIG. 6 is a depiction of the winding frame with mounted pole piece.

FIG. 7 is a graphical plot of the spool vs. pole movement.

FIG. 8 is a depiction of the 1 meter device concept.

FIG. 9 is the wire path within the super-mini undulator.

FIG. 10 is the finished assembly.

FIG. 11 shows the vertical test facility assembly (view 1).

FIG. 12 shows the vertical test facility assembly (view 2).

FIG. 13 shows the vertical test facility assembly (view 3).

### DETAILED DESCRIPTION OF THE INVENTION

Provided herein is a detailed description of one embodiment of the invention. It is to be understood, however, that the present invention may be embodied with various dimensions. Therefore, specific details enclosed herein are not to be interpreted as limiting, but rather as a basis for the claims and as a representative basis for teaching one skilled in the art to employ the present invention in virtually any appropriately detailed system, structure, or manner.

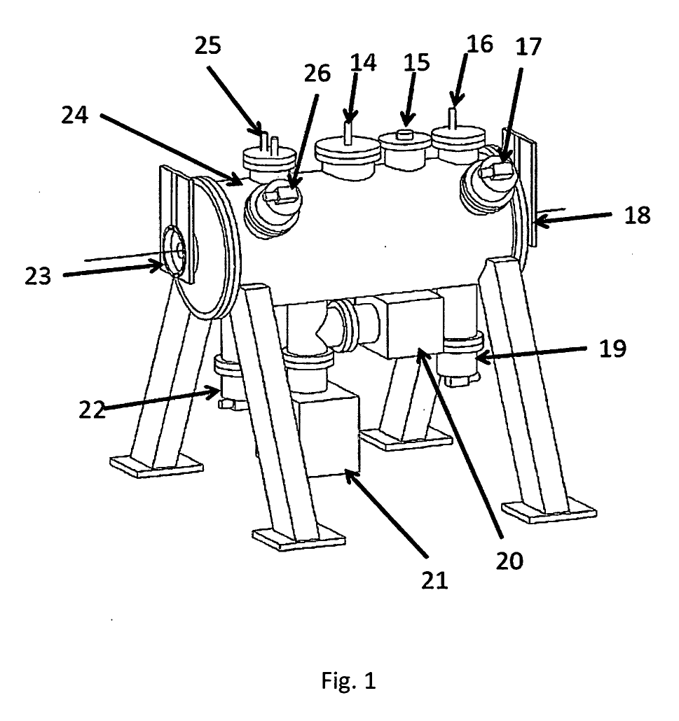

FIG. 1 shows the overall cryostat design that ADC plans to construct. The outside of a cryostat vessel 24 consists of thermal buffer operation/safety 14 and 16, a safety pop-off valve 15, a gate valve 18, a beam gate valve 23, and current leads 25. It contains a cold mass with a support structure, radiation shields, wherein the cold mass temperature is maintained by cryocoolers 17, 19, 22, and 26, connected to the outside of the cryostat vessel 24. A vacuum within the vessel 24 is maintained by a turbo/roughing pump 20 and ion pump 21. The old mass includes a superconducting (SC) magnet, a liquid helium (LHe) vessel with piping, and a cold beam chamber with thermal links to the cryocoolers. Cold mass is structurally supported by a base frame. LHe flows from the LHe vessel into the SC magnet cores and returns into the LHe vessel. The vapor is then re-condensed into liquid in the vessel 24.

We have foreseen four cryocoolers 17, 19, 22, and 26, but have also added a helium fill/vent turret which would not be needed for a fully cryogen-free design. On the other hand, we could plan for a volume in which we condense gaseous helium (GHe) to LHe as a better buffer for quenches and power load. This would avoid the cool-down and filling procedure with LHe, but would offer a larger heat capacity for transient heat load peaks. We plan to add a safety valve burst disk at the smaller turret on top of the cylindrical cryostat vessel 24.

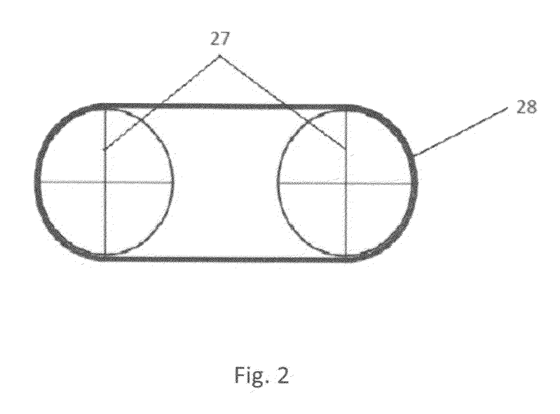

The super-mini undulator involves a single SC wire 28 that is wrapped around two identical bobbins 27 each about 50 mm in diameter. The wire 28 is initially wrapped under tension in a “racetrack” formation as shown in FIG. 2.

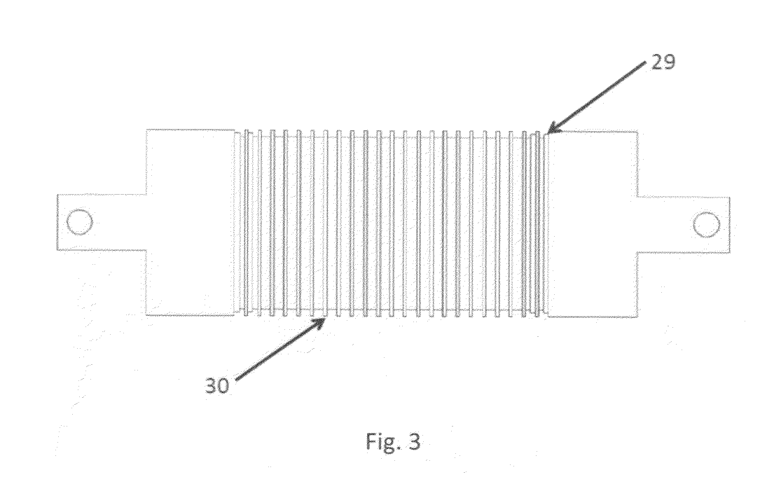

The bobbins 27 are machined with grooves to accept wires that are rectangular. The bobbins, however, could also be machined to accept wires of different shapes. In this embodiment, the wire 28 is wound around both bobbins with 4 turns per groove. The two end section grooves have only have 3 turns per groove. FIG. 3 shows an actual bobbin in which the end sections show a stepped groove 29 in which one wire segment 30 would be replaced by the material of the bobbin.

In the prototype, the grooves are separated by 7 mm and the entire length of the prototype is 100 mm. The bobbins are first wound bifilarly in one direction filling every other groove alternating top and bottom. After the first set of grooves are filled, the wire is reversed and the remaining grooves are filled. This produces a set of wire segments in which the currents run in opposite directions on the top and bottom of the bobbins to produce the undulating field. The wires are parallel between the spools but must crossover each other on the outside of the bobbin in order to fill alternating grooves. The wires are wound in such a way that within a single turn, a wire segment in the top groove returns on the adjacent groove on the bottom. The bobbins are entirely wound in the forward direction first and then the reverse.

Four turns are made on each full groove before moving to the next “forward” groove skipping a “reverse” groove. The wire is reversed at a turning nut before the reverse grooves are filled. One can see that providing a separate and distinct groove that supports the wire all the way around the outside of the spool is a difficult task. Grooves must be cut in an “S” pattern on a curved surface at varying depths. Initial attempts at producing a point-to-point (P-P) tool path that a computer numerical control (CNC) machine could execute were dropped in favor of a smooth outer spool surface.

The forward wires are wound and then potted with epoxy before winding the reverse wires which are also potted in epoxy to maintain wire position in bobbin grooves. This is a compromise that would be corrected by devising a mathematical model that would then generate the P-P tool path. Once this is done, modifications to a standard CNC milling machine would be necessary to include the extra axes needed to deal with the curved surface and varying depths.

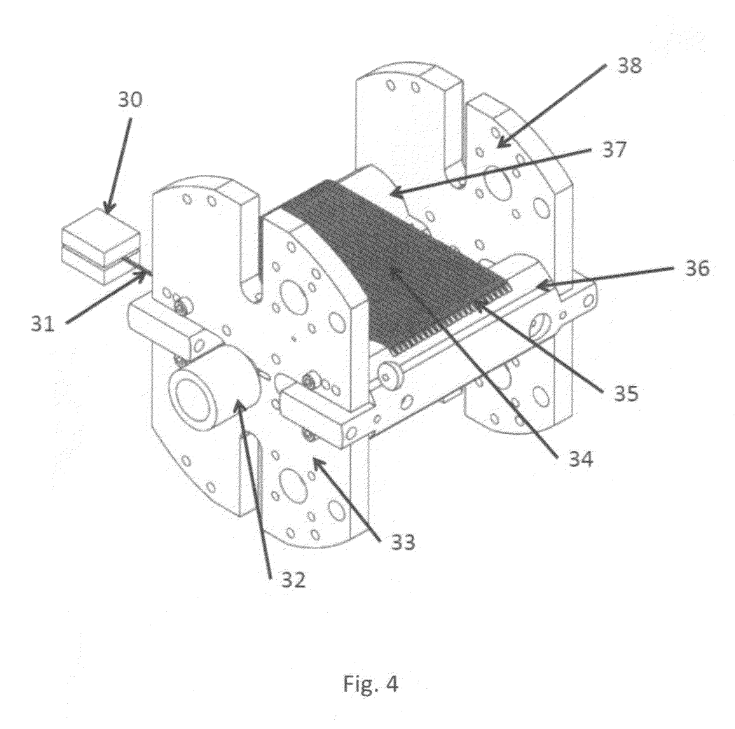

FIG. 4 shows a mounting structure to support the wound bobbins, in which the bobbins 27 and wire 28 are sandwiched between a front end plate 33 and a rear end plate 38. The windings 34 must be held under tension. The parts associated include the spool 30, drive spindle 31, guide 32, front end plate (20), mounted SC wire 35, right bobbin 36, left bobbin 37.

Studies have shown that superconducting wire does not typically fail to super-conduct until the tension is such that the copper surrounding the superconducting fiber matrix yields. Nonetheless, the winding mechanism includes a tension monitor.

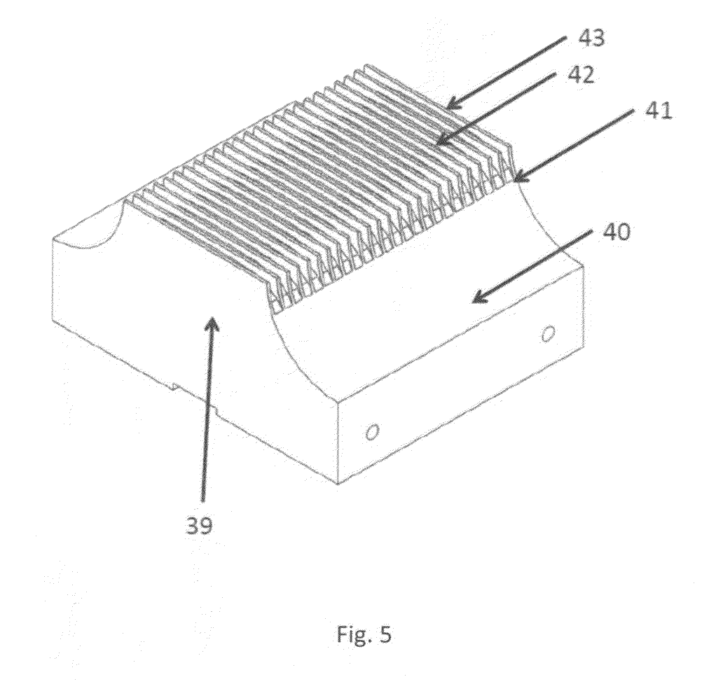

Once the bobbins have been wound and the outside potted, pole pieces made of vanadium permendur are mounted above and below the bobbins on the same winding frame. The poles have a base 39 that supports pole grooves 42 and pole crowns 43 to accept the SC wire segments as shown in FIG. 5. The groove bottoms are slightly crowned in the center while the top of the groove is flat. The poles are designed this way in order to gently assist the wire segments into their respective grooves during transformation by means of the transformation grooves 41 at each end of the pole grooves 42. The poles must be placed in sync with the bobbins in order to maintain tension throughout the entire SC wire, and allow gradual movement of the bobbins through contact with curved bobbin relief regions 40.

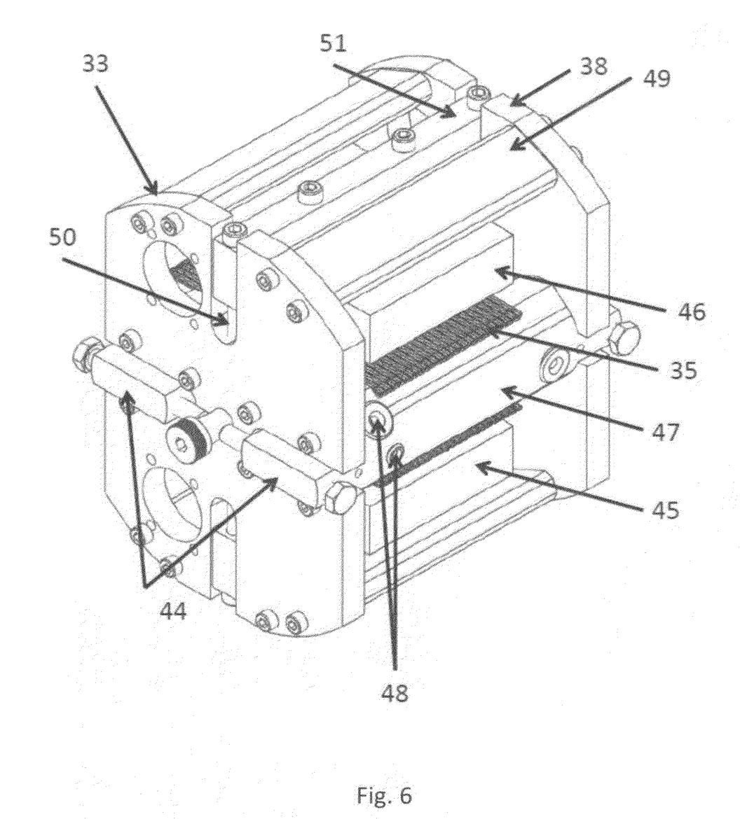

The racetrack configuration is “transformed” into the final configuration by moving the upper pole piece 46 and lower pole piece 45 closer together along the vertical axis while the mounted bobbins 47 are brought closer together along the horizontal axis. This is performed while these components are constrained between the front end plate 33 and rear end plate 38. After the transformation is complete, the final gap between the upper pole piece and lower pole piece should be about 2 mm. The winding frame with the pole pieces mounted is shown in FIG. 6. Transformation screws 44 on either end of the bobbins and pole pieces are used to manually reduce the gap between the bobbins and pole pieces during transformation. One can also see the direction reversing nuts 48 at one end of one of the bobbins, along with a guide bar 49, guide slot 50, and stiffener 51 for controlling the position of the upper pole piece 46. This winding process is manual for this prototype but would be automated for a longitudinally longer device.

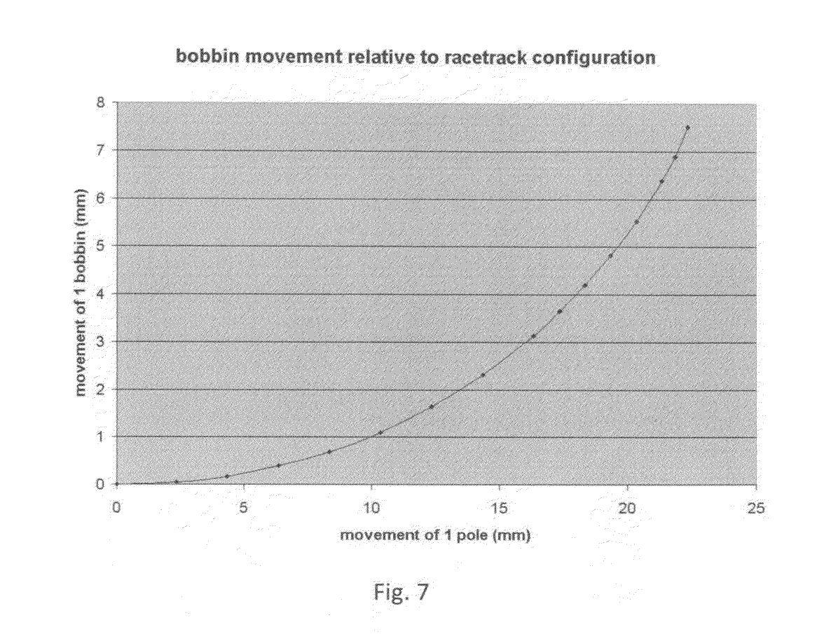

As the pole pieces are brought together, the bobbins must also move closer together to maintain the same tension on the wires. A plot of the bobbin movement vs. pole movement is shown in FIG. 7. One can see the relationship is non-linear. Note that care must be exercised during this transformation to ensure that undue tension is not produced in the wire. Once the desired positions of the pole pieces are reached, the necessary gap end caps are placed to maintain the gap between the pole pieces.

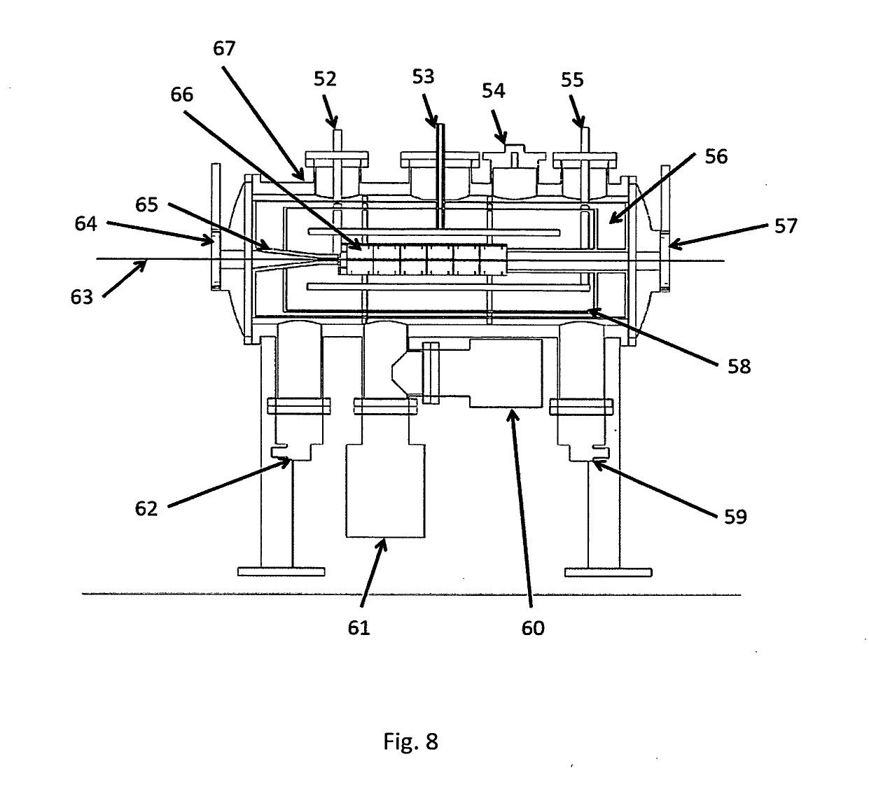

For the prototype, the process of moving the pole pieces and bobbins is a simple but tedious process which requires that an operator manually turns the eight controlling screws in a pattern by a specific amount and then measures the effect with a depth gauge. For a 1 meter device as depicted in a transparent view in FIG. 8, it would be helpful to make this process more automated. A completed 1 meter device encompasses, but is not limited to, the following components: power connections 39, a thermal buffer operation/safety 53, a vessel safety valve 54, a thermal buffer operation/safety 55, liquid nitrogen shielding 56, a gate valve 57, 20K shielding 58, a plurality of cryocoolers 59 and 62, a turbo/roughing pump 60, an ion pump 61, a gate valve 64, and an RF beam funnel 65. The completed undulator 66 is housed within a vacuum chamber 67. The electron beamline 63 is depicted passing through the undulator 66.

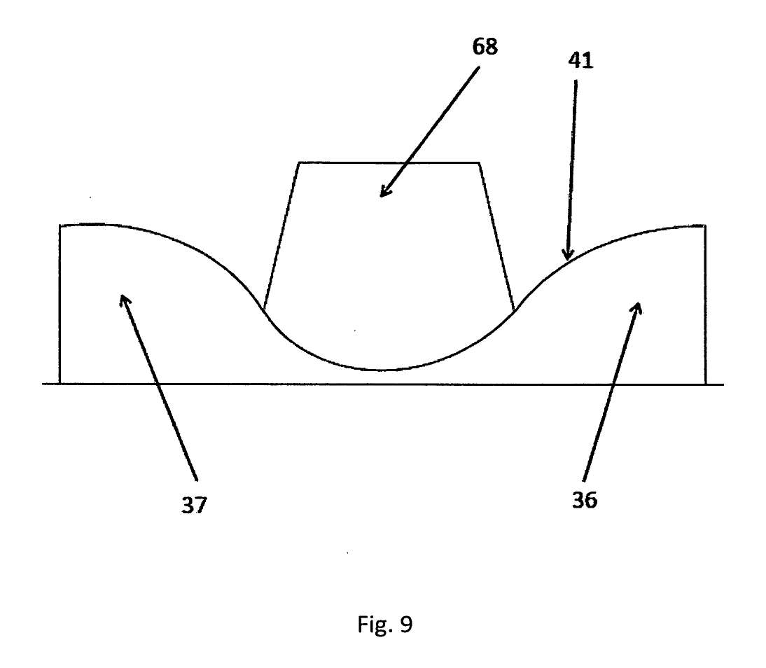

Once the device is fully transformed, the wound wire will take the shape shown in FIG. 9, which depicts the cross-section of the wire path as it passes between the right bobbin 36, left bobbin 37, and under the upper pole piece 68. This figure only shows the upper half, but the lower half is a mirror image. The position in which the wire meets the transformation groove 41 is also shown.

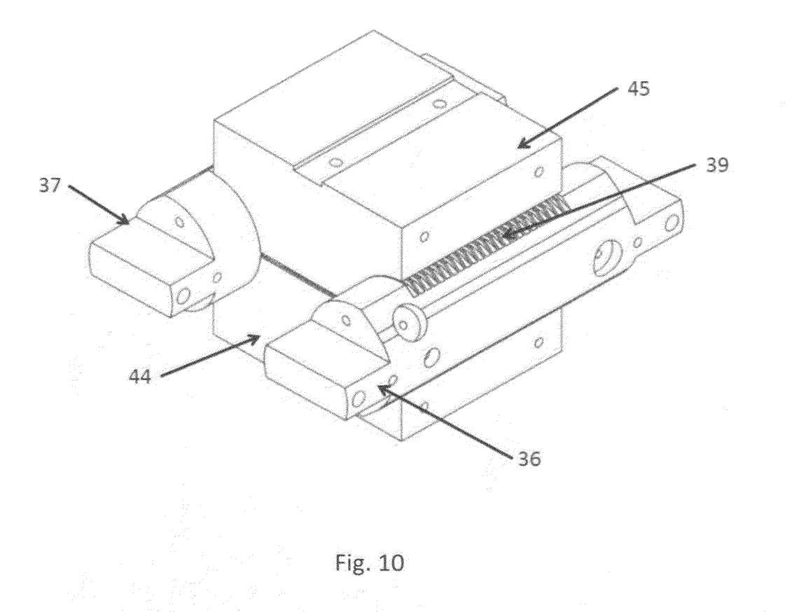

After transformation, sides are added to hold the bobbins and pole pieces together. The finished assembly is shown in FIG. 10. This figure depicts previously mentioned components, including right bobbin 36, left bobbin 37, pole base 39, transformation screws 44 and lower pole piece 45. Connection points are added for copper bus bars on either end of the bobbins.

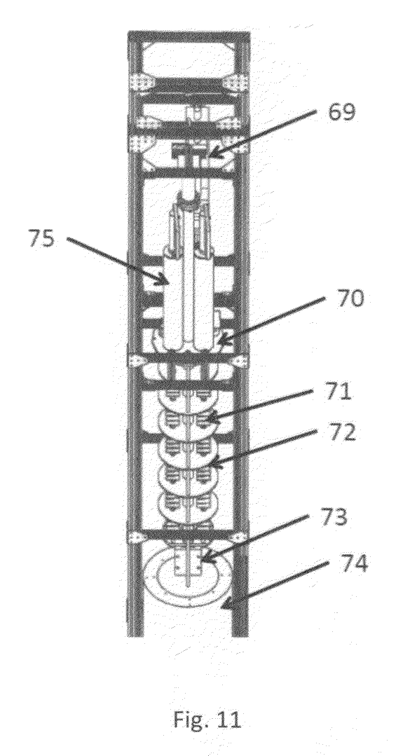

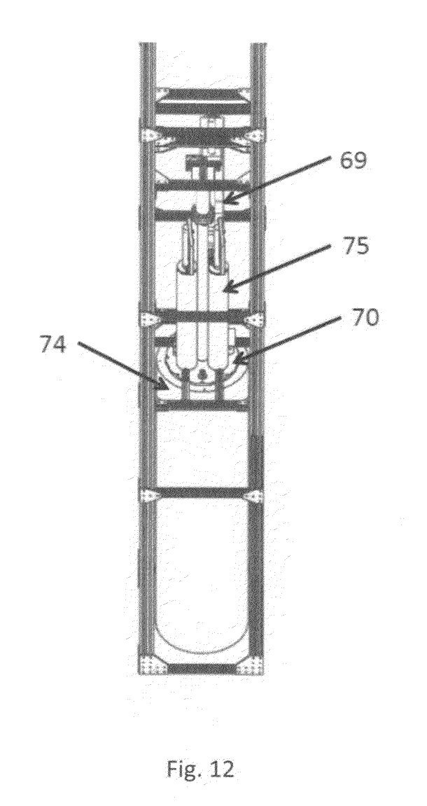

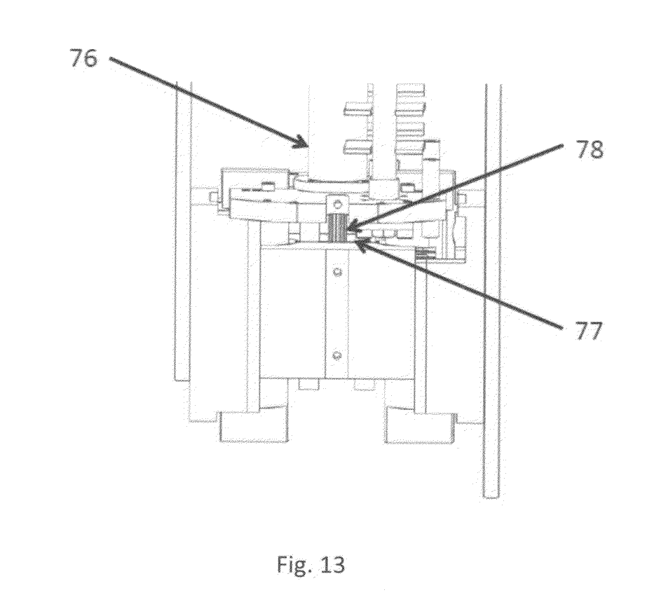

FIGS. 11, 12 and 13 illustrate a vertical test facility (VTF), which is required to verify the superconducting current density and magnetic field produced by the super-mini undulator. The VTF encompasses a Dewar 74, power rods 71, pre-cooling power rod vacuum sleeves 75, heat shield baffles 72, and the prototype super-mini undulator 73. The undulator is structurally supported by the Dewar lid 70 by the power rods that supply a current on the order of 1000 amps to the superconducting coil. Since it is supported from the Dewar lid, it is possible to get accurate magnetic field readings from a Hall sensor, which is fed down the center baffle support rod 76. The Hall sensor 78 should be placed inside of the gap of the transformed wire coil in the superconducting undulator 77. The position of the Hall sensor can be controlled using a linear positioning slide 69. An ADC DS400-200, for example, could be used for this purpose.

The VTF consists of a liquid helium Dewar 74 within which the super-mini undulator 73 is immersed. This Dewar is pre-cooled with liquid nitrogen, as are the copper bus bars. The copper bus bars, however, create a significant heat leak and must be pre-cooled to reduce the temperature differential between the LHe bath and the outside ambient temperature. The copper bus bars must be quite large (1.125 inches in diameter in this embodiment) to carry the required current density.

A power supply with 1000 amps at 10 volts is suggested. The LHe level is monitored with a level detector as is the temperature of the undulator. A quench protection circuit is provided to shut down the power supply in the event of a quench. If a quench occurs, the power supply is quickly shut down allowing a high current freewheeling diode to shunt any high voltage spikes caused by the collapsing field around the supply, thereby protecting the output circuitry.

Encapsulated Hall probes are too thick to fit within the wire coil gap. Therefore, the field should be measured with a cryogenic, bare, Hall probe that is approximately 0.7 mm thick. The Hall probe is attached to a support rod 76 that moves up and down within a central tube. Guidance for the Hall probe is provided inside the tube. The tube is then attached to a framework that is also attached to the end of the undulator. Heat shield baffles 72 are attached to the central tube. Similar but smaller baffles are attached to the copper bus bars to take advantage of the cold He gas at the top of the Dewar 74.

An ADC stage, at room temperature, is located above the top cap of the Dewar 74. The stage connects to the central rod and moves the Hall probe up and down while keeping track of the probes position with an encoder. The Hall probe must be able to travel 5 periods beyond each end to attain a reasonable zero field. The expected field has been predicted to be 1.1 T using RADIA calculations. On the lid the linear positioning slide 69 is placed to supply a 300 mm linear displacement for the hall probe. This allows for a data collection of magnetic flux changes generated by the superconducting undulator.

The embodiment described herein currently supports a 7 mm period, K factor of 0.72, gap of 2 mm, 10 periods with 4 end periods. This would produce a field of 1.1 T with an expected current density of 1000 A/mm². The overall length of the prototype device is 100 mm. However, one of ordinary skill in the art of undulator design would be able to extrapolate the device length based on the design considerations disclosed herein.

It is to be understood that the embodiment disclosed herein is not indented to limit the scope of the invention to a particular form set forth. On the contrary, it is intended to cover such alternatives, modifications, and equivalents as may be included within the spirit and scope of the invention as defined by the claims.

1. A method of constructing a super-mini undulator apparatus as described by comprising:
(a) a single spool of super conducting wire;
(b) a framework for holding the super mini in a racetrack form;
(c) a means of rotating the super-mini and framework to wind the SC coils;
(d) a means for holding the wires on the outside of the bobbin;
(e) a means to transform the super-mini from racetrack to undulator form;
(f) a means to include the bobbins in the transformation;
(g) a means to include the pole pieces in the transformation, and;
(h) a means to transform the super-mini from racetrack to undulator form by controlling the non-linear relationship between pole and bobbin motion simultaneously.

2. The method of claim 1 wherein said super-mini construction includes SC wire
a) held in place using cryogenic epoxy after wrapping forward; and
b) held in place using cryogenic epoxy after wrapping back.

3. The method of claim 1 wherein said superconducting wire can be comprised of a rectangular shape

4. The method of claim 1 wherein said superconducting wire is wound in a racetrack format and then transformed to an undulator format

5. The method of claim 1 wherein a framework is used to transform the racetrack form to the undulator form.

6. The method of claim 1 wherein a framework is used to transform the racetrack form to the undulator form that compensates for the non-linear and unequal movement of the bobbin and pole pieces during transformation.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)
